(19) United States
(12) Patent Application Publication
(10) Pub. No.: US 2008/0210711 A1
(43) Pub. Date: Sep. 4, 2008

(54) Dispenser for liquid to paste-like masses

(75) Inventor: Martin Riesle, Villingen-Schwenningen (DE)

Correspondence Address: COLLARD & ROE, P.C., 1077 NORTHERN BOULEVARD, ROSLYN, NY, 11576, US

(73) Assignee: MegaPlast GmbH & Co. KG

(21) Appl. No.: 12/072,102

(22) Filed: Feb. 22, 2008

(30) Foreign Application Priority Data
Feb. 23, 2007 (DE) 20 2007 002 677.3

(51) Int. Cl. B67D 5/00; B65D 88/54

(52) U.S. Cl. 222/153.13; 222/336

(57) ABSTRACT

A dispenser for liquid to paste-like masses has a dispensing opening, a supply chamber, and a piston disposed in the supply chamber, which moves in the direction of the dispensing opening with a decreasing supply. A spring acts on the piston, in the movement direction of the piston. The mass therefore constantly stands under the pressure that is exerted on the piston by means of the spring.

### CROSS REFERENCE TO RELATED APPLICATIONS

Applicant claims priority under 35 U.S.C. §119 of German Application No. 20 2007 002 677.3 filed Feb. 23, 2007.

### BACKGROUND OF THE INVENTION

1. Field of the Invention

The invention relates to a dispenser for liquid to paste-like masses, having a dispensing opening, a supply chamber, and a piston disposed in the supply chamber, which moves in the direction of the dispensing opening with a decreasing supply of the mass.

2. The Prior Art

Such dispensers are known in multiple configurations. For example, reference is made to German Publication No. DE 20 2004 019 763 U1.

In the case of known dispensers of this type, a pump chamber is formed, with which the mass is drawn in from the supply chamber and then dispensed from the dispensing opening when the pump is activated. Furthermore, it is also known, in the case of more complicated configurations, for example German Patent No. DE 200 01 409, to act on the piston with a motor for dispensing. In this connection, pump aspiration is not required.

### SUMMARY OF THE INVENTION

It is therefore an object of the invention to provide a dispenser of the type stated initially, which allows reliable dispensing while having a simple structure.

This object is accomplished according to the invention in that the piston is acted on by a spring, in its movement direction. The mass therefore constantly stands under the pressure that is exerted on the piston by means of the spring. All that needs to take place for the dispensing is for the dispensing opening to be opened, and mass exits on its own. A complicated pump chamber can be eliminated, but additional aspiration can also be provided in an individual case, for example if the spring action is used only for support.

The spring is preferably configured in a conical shape, in a side view. In this way, advantageous utilization of a given space is achieved. The piston can be moved over a great length, without the initial position being limited by ossification of the spring. In this connection, it is furthermore preferred that the cone tip points in the movement direction of the piston. Therefore, contact on the bottom of the supply chamber exists over the broad surface of the cone, i.e. in the case of a corresponding helical spring, by way of the spring winding having the greatest diameter, while the contact on the piston exists by way of the spring winding having the smallest diameter. Since the piston is generally stabilized on the supply housing by means of axially spaced sealing lips, in any case, contact of the winding having the smallest diameter on the piston is sufficient for stable guidance.

Although it is possible to use the spring only as support for aspiration or other action on the mass with regard to issuance from the dispensing opening, it is preferred, however, that the mass is dispensed solely by the pressure of the spring.

Regarding the dispensing opening, an activation part is preferably provided, and this activation part is to be activated by pressure application in the direction of the piston. In this connection, it is particularly suitable to dispose the activation part in a surface of the dispenser that runs parallel to the piston plane, i.e. a plane that runs perpendicular to the longitudinal axis of the dispenser, so that it can be activated from above, by simple pressure.

It is suitable if the activation part is also the closure part. Sealing surfaces are formed in an integral manner, which interact with counter-sealing surfaces of the housing, forming a seal.

In a further detail, a cone-shaped recess is particularly advantageous in this regard, which interacts with a counter-cone that narrows toward the top. The pressure of the mass that is ready for dispensing, by means of the piston, therefore leads to an increase in the closing pressure, by itself, in each instance. In addition, it is suitable if spring activation of the activation part into the closed position is preferably provided. The spring activation can be applied by a suitable configuration of the activation part itself. Alternatively, it is also possible to provide a separate spring element that acts on the activation part.

Another aspect of the invention relates to securing the piston in its starting position. For this purpose, a transport lock is preferably provided. The transport lock consists, in suitable manner, of a securing part that interacts with the container, with shape fit, and interacts with the piston in a releasable shape-fit manner. The piston is only released after intentional activation of the securing part, and only then is pressure exerted on the mass.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a cross-sectional view of a first embodiment of the dispenser, having a piston situated in the transport lock;

FIG. 2 shows the dispenser according to FIG. 1, with the piston released, situated in an intermediate position;

FIG. 3 shows the dispenser with the piston situated in the upper end position;

FIG. 4 shows a perspective view of the piston from below;

FIG. 5 shows a view of the transport locking part from above;

FIG. 6 shows a cross-section through the object according to FIG. 5, cut along the line VI-VI;

FIG. 7 shows a cross-sectional representation of a second embodiment of the dispenser, corresponding to FIG. 1;

FIG. 8 shows the dispenser according to FIG. 7, with the piston released, situated in an intermediate position; and

FIG. 9 shows the dispenser according to FIG. 7, with the piston situated in the upper end position.

### DETAILED DESCRIPTION OF THE PREFERRED EMBODIMENT

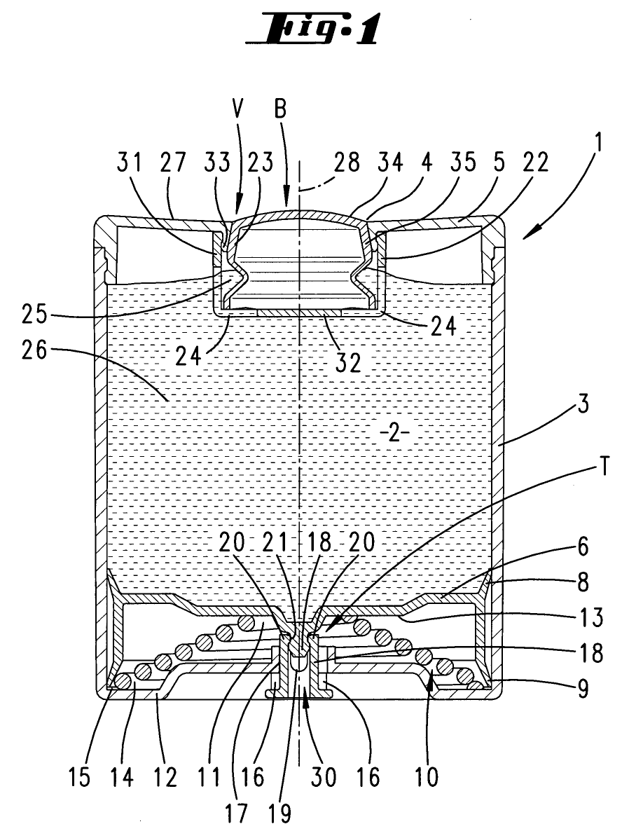

Referring now in detail to the drawings and, in particular, FIG. 1, a dispenser 1 is shown and described in a first embodiment, which consists of an essentially beaker-shaped container part 3 forming a supply chamber 2, and an upper part 5 attached to the former with catches, forming dispensing opening 4.

A piston 6 is disposed in supply chamber 2, which can be displaced to slide on inside wall 7 of container part 3, by means of two sealing lips 8, 9 that are axially spaced apart in the exemplary embodiment.

Piston 6 has pressure applied to it by a spring 10, in its movement direction toward dispensing opening 4.

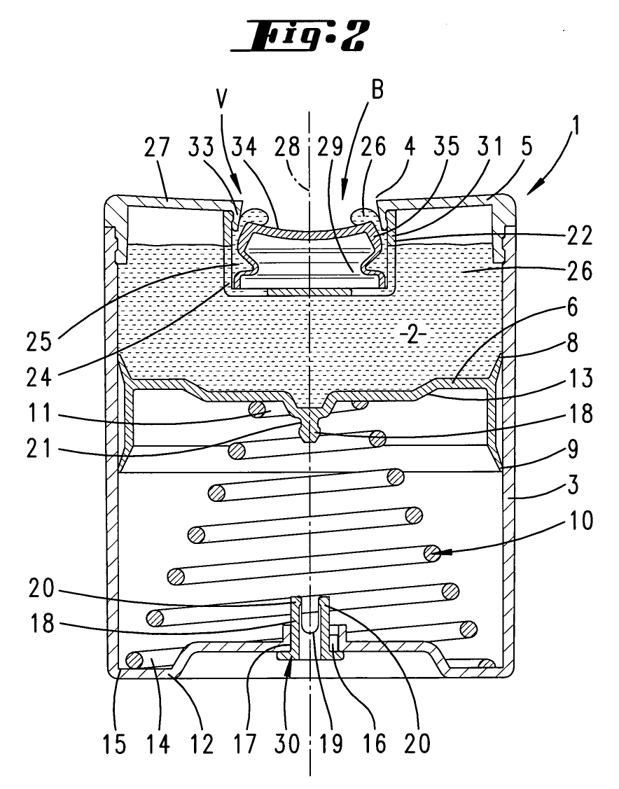

Spring 10 is formed from a spring wire, as a usual metal spring. Spring 10 is furthermore configured as a helical spring that runs in a cone shape, in a side view, both in the compressed state (FIG. 1) and in the expanded state (FIG. 2). In this connection, the cone tip is directed toward piston 6. An end winding 11 of spring 10, which has the smallest diameter, lies against underside 13 of piston 6 that faces the container bottom 12.

A spring winding 14 having the greatest diameter rests on container bottom 12 close to a corner region 15 of container part 3, with reference to the cross-sectional representation according to FIG. 1.

The cone shape is evidently selected in such a manner that the diameter ratio of the smallest to the largest winding is 1:2 or more; in the exemplary embodiment, it is approximately 1:3.5. Ratios of 1:3, 1:4, or 1:5, or also intermediate values, are also easily possible.

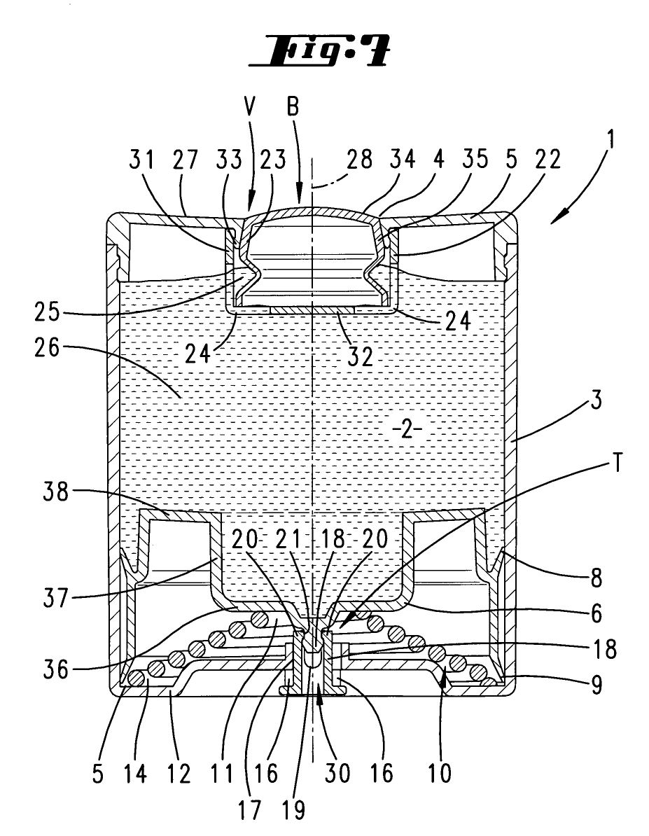

Furthermore, a transport lock T is provided in container bottom 12. For this purpose, a shape-fit securing part 30 is disposed in bottom 12, which part is shown in FIGS. 5 and 6, also in further detail.

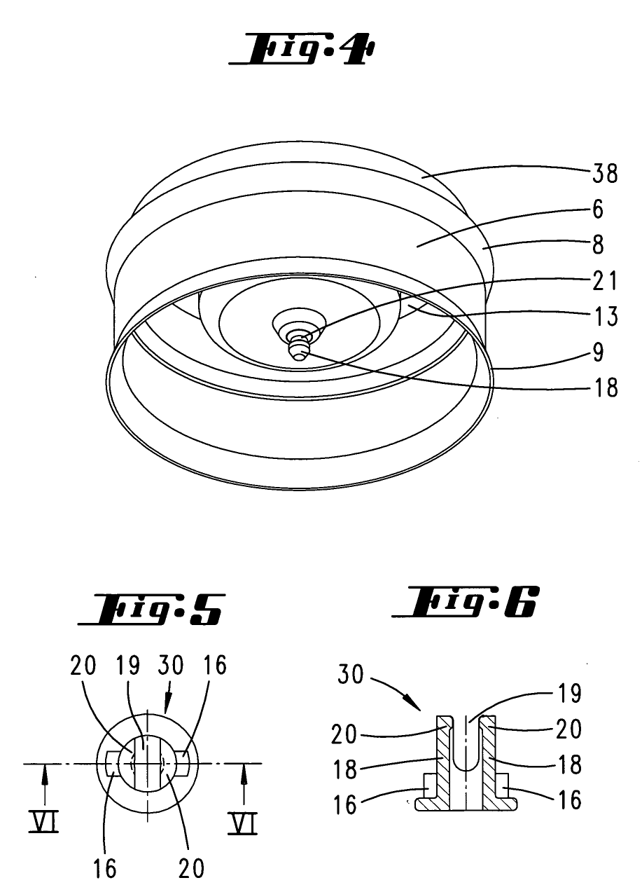

This shape-fit securing part 30 interacts with a holder projection 18 formed on piston 6. This holder projection 18 is configured with rotation symmetry, as is also evident from the perspective view of piston 6 from below, according to FIG. 4. The shape-fit securing part 30 has two locking projections 16, although in some cases only one might be required, so that the part can be locked in the position shown in FIG. 1, by rotation relative to a keyhole-like perforation 17 in container bottom 12.

In this position, deformations 33 of container bottom 12 that extend axially act on socket sections 20 of securing part 30, formed in a flexible manner by opposite incisions 19, so that elastic bending of the arms that carry socket sections 20 is suppressed.

Accordingly, holder projection 18 of piston 6 is captured in securing part 30 by undercuts 21 that are provided; this is done by engagement of socket sections 20 on the securing part side in the undercut region of holder projection 18.

After rotation and upward movement of securing part 30, when projections 16 move into the related recesses of the container bottom 12, the elasticity of socket sections 20 is released, and piston 6 can come free from transport lock T, on the basis of the force of spring 10. The force of spring 10 is accordingly set to be greater than the recovery spring force of socket sections 20.

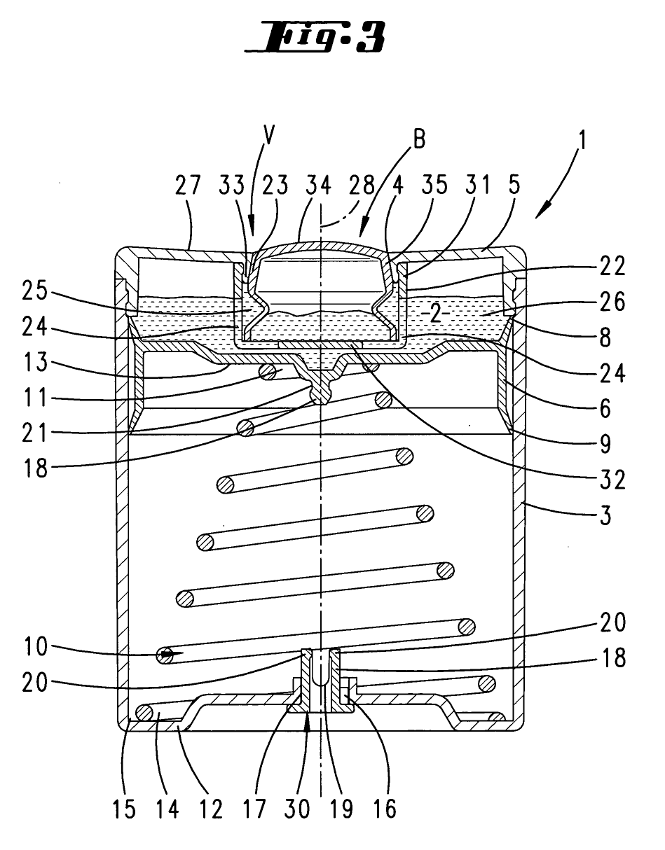

FIG. 3 shows the practically completely emptied position of dispenser 1. Piston 6 has moved upward, practically all the way to the stop against an accommodation part 22 for a sealing part 23, which sits in dispensing opening 4 and forms a combination of activation part B and closure valve V for dispensing opening 4, in the exemplary embodiment.

Accommodation part 22, which is pot-shaped, in total, possesses perforations 24 through which the mass can flow into ring-shaped interstice 25 between sealing part 23 and accommodation part 22. Perforations 24 are formed in the circumferential corner region that points in the direction of piston 6, leaving a closed central section in pot bottom 32 and a closed upper collar section 31 that runs around the circumference. Accommodation part 22 is held between the latter and an upper part collar 33 that surrounds dispensing opening 4, by means of a shape fit.

When sealing part 23 is pressed down, as shown in FIG. 2, mass 26 can exit and is also lifted upward by the released sealing part 23, into the region of surface 27 of dispenser 1.

Surface 27 is formed in a slight funnel shape, dropping toward sealing part 23. Apart from that, it extends practically perpendicular to a longitudinal axis 28 of the dispenser.

Sealing part 23 can be a plastic part that is also elastically biased into the sealing position, because of fold formation 29. The latter is necessary, in any case, if piston 6 is captured by transport securing part 30, in other words spring 10 does not act on mass 26.

Sealing part 23 interacts with the related wall of upper part collar 33 that surrounds dispensing opening 4, forming a seal, on the circumference, close to activation surface 34 on the top. The corresponding sealing section 35 is structured in cone shape. Upper part collar 33 forms a counter-cone that also narrows toward the top, i.e. facing away from piston 6, just like sealing section 35.

In the transport-secured basic position according to FIG. 1, supply chamber 2 is filled with mass 26, leaving a clear space that occurs on the underside of the upper part lid section. The mass level is approximately at a separation line between container part 3 and upper part 5, furthermore at approximately half the vertical height of pot-shaped accommodation part 22. Passing through perforations 24, mass 26 is also present, in part, in interstice 25, as well as in activation part B that is configured as a hollow body and opens downward, in the direction toward accommodation part bottom 32.

When activation part B is pressed down in the transport-secured position according to FIG. 1, no mass 26 is dispensed, because of the absence of pressure activation and the unfilled free space that faces dispensing opening 4.

After transport lock T has been released, and the spring force that acts on mass 26 has been triggered, by way of piston 6, the ceiling-side free space is filled with mass 26 at least up to an upper level of perforations 24. Interstice 25 and, in part, the cavity of activation part B, also fill with mass 26. Sealing part 23 is pressed into the conical sealing seat by way of mass 26 and an air cushion that might be left between mass 26 and the sealing part ceiling.

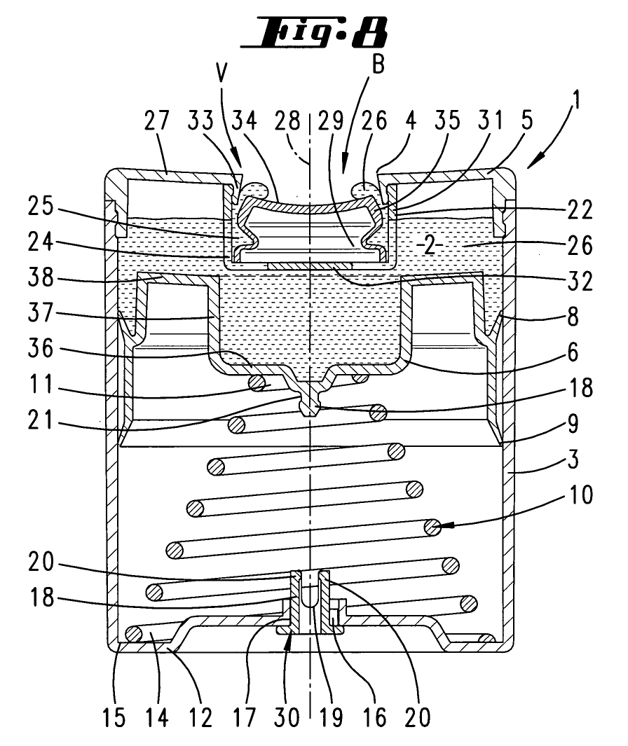

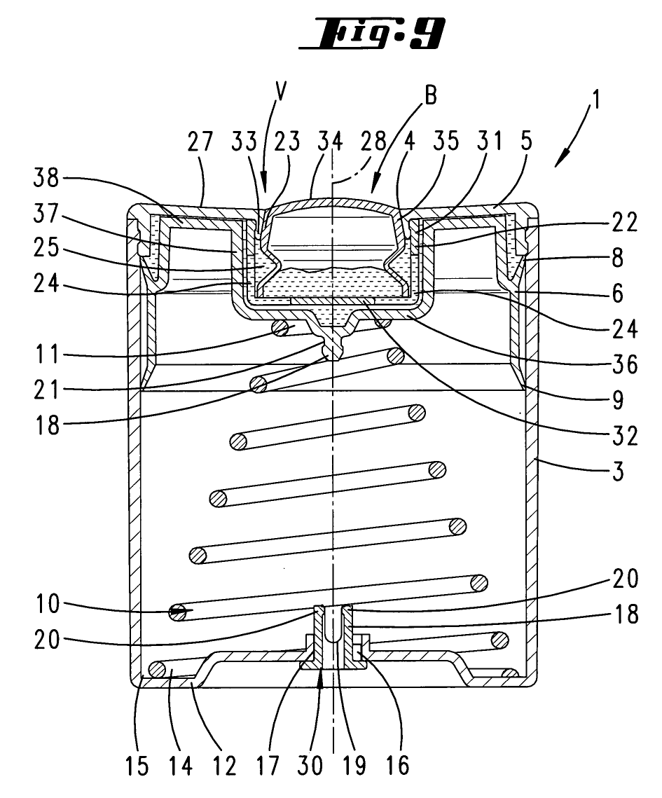

FIGS. 7 to 9 show dispenser 1 in a second embodiment. This is essentially composed analogous to the first exemplary embodiment, and for that reason, the same components carry the same reference numbers.

As compared with the first embodiment, in this embodiment piston 6 is changed in shape, particularly in the region of the piston crown. While the piston crown in the first embodiment is configured in approximately planar manner between the circumferential ring belt that has sealing lips 8 and 9, with slight lowering of a central section, in the second embodiment, an approximate adaptation of the piston crown cross-section to the cross-section of the upper part 5 with accommodation part 22 is provided. Accordingly, a central section of the piston crown is formed in a pot-like manner, with a pot bottom 36 that runs perpendicular to longitudinal axis 28, and a circumferential pot wall 37 that is oriented concentric to longitudinal axis 28. The inside diameter as well as the axial height of pot wall 37 are adapted to the outside diameter and the axial height of accommodation part 22, so that the latter finds accommodation in the pot section on the piston crown side, in the completely raised piston end position according to FIG. 9.

The end region of pot wall 37 that faces away from the pot bottom 36 makes a transition into a ring collar 38 that projects essentially radially outward. This collar is adapted, in total, to surface 27, and is structured slightly in funnel shape, dropping toward the pot section. Piston 6 lies against this ring collar 38 with its full area in the completely advanced position, inside the upper part.

By means of the selected configuration of piston 6 according to the second embodiment, approximately complete emptying of the mass can be achieved. The residual volume is reduced to a minimum.

The disclosure content of the related priority documents referenced above is also incorporated into the disclosure of this application, with its full content.

Accordingly, while only a few embodiments of the present invention have been shown and described, it is obvious that many changes and modifications may be made thereunto without departing from the spirit and scope of the invention.

What is claimed is:

1. A dispenser for liquid to paste-like masses, comprising:
a supply chamber;
a dispensing opening in the supply chamber;
a piston disposed in the supply chamber, said piston moving in a direction of the dispensing opening with a decreasing supply of mass in the supply chamber; and
a spring acting on the piston, in the movement direction of the piston.

2. The dispenser according to claim 1, wherein the spring has a longitudinal cross section that is configured in a cone shape.

3. The dispenser according to claim 2, wherein a tip of the spring points in the movement direction of the piston.

4. The dispenser according to claim 1, wherein the mass is dispensed solely by means of pressure from the spring.

5. The dispenser according to claim 1, wherein the dispensing opening has an activation part.

6. The dispenser according to claim 5, wherein the activation part is activated for opening by application of pressure in the movement direction of the piston.

7. The dispenser according to claim 5, wherein the activation part also forms a closure valve.

8. The dispenser according to claim 1, wherein the piston is held in a starting position by a transport lock.

9. The dispenser according to claim 8, wherein the transport lock consists of a securing part that interacts with the supply chamber with a shape fit, and interacts with the piston with releasable shape fit.
